(19) United States
(12) Patent Application Publication
(10) Pub. No.: US 2025/0071719 A1
(43) Pub. Date: Feb. 27, 2025

(54) POSITIONING REFERENCE SIGNAL CONFIGURATION AND MEASUREMENT UPDATE

(71) Applicant: Nokia Technologies Oy, Espoo (FI)

(72) Inventors: Tao TAO, Shanghai (CN); Ryan KEATING, Naperville, IL (US); Yan MENG, Shanghai (CN); Jianguo LIU, Shanghai (CN)

(21) Appl. No.: 18/721,103

(22) PCT Filed: Feb. 7, 2022
(86) PCT No.: PCT/CN2022/075359

§ 371 Date: Jun. 17, 2024

(51) Int. Cl. H04W 64/00; H04L 5/00; H04W 24/10

(52) U.S. Cl. CPC H04W 64/00; H04L 5/0051; H04W 24/10

(57) ABSTRACT

Various example embodiments relate to methods and apparatuses for positioning reference signal configuration and measurement update. An apparatus in a communication network may be configured to transmit to a location server in the communication network information of one or more non-preferred resources for positioning reference signal, PRS, measurement at a terminal device in the communication network, and receive a positioning configuration related indication from the location server. The positioning configuration related indication is obtained in connection with the transmitted information and it indicates the apparatus to update a positioning configuration to reduce PRS measurement of the terminal device on the one or more non-preferred resources.

### TECHNICAL FIELD

Various example embodiments described herein generally relate to communication technologies, and more particularly, to methods and apparatuses for positioning reference signal (PRS) configuration and measurement update to improve PRS transmission and reception efficiency.

### BACKGROUND

Certain abbreviations that may be found in the description and/or in the figures are herewith defined as follows:
gNB next Generation Node-B
LMC Location Management Component
LMF Location Management Function
MAC Medium Access Control
MG Measurement Gap
NR New Radio
NRPPa NR Positioning Protocol a
PPW PRS Processing Window
PRS Positioning Reference Signal
QCL Quasi-CoLocation
RAN Radio Access Network
RRC Radio Resource Control
RSRP Reference Signal Received Power
RSTD Reference Signal Time Difference
SSB Synchronization Signal Block
TRP Transmission Reception Point
UE User Equipment

Cellular network based positioning technology includes a trilateration or multilateration method where a user equipment (UE) measures positioning reference signals (PRSs) transmitted from multiple base stations to obtain reference signal time difference (RSTD) of the PRSs, from which a location server who has position coordinates of the base stations can estimate UE location. In 3GPP specification Rel. 16, a UE is always configured with a measurement gap (MG) when performing positioning measurements. However, MG request and configuration would cause additional positioning latency. Hence, it is expected that positioning measurement outside MG would be supported in the future.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of an apparatus in a communication network is provided. The apparatus may comprise at least one processor and at least one memory including computer program code. The at least one memory and the computer program code may be configured to, with the at least one processor, cause the apparatus at least to transmit to a location server in the communication network information of one or more non-preferred resources for positioning reference signal, PRS, measurement at a terminal device in the communication network and receive a positioning configuration related indication from the location server. The positioning configuration related indication is obtained in connection with the transmitted information and it indicates the apparatus to update a positioning configuration to reduce PRS measurement of the terminal device on the one or more non-preferred resources.

In a second aspect, an example embodiment of an apparatus in a communication network is provided. The apparatus may comprise at least one processor and at least one memory including computer program code. The at least one memory and the computer program code may be configured to, with the at least one processor, cause the apparatus at least to receive from a location server in the communication network information of one or more non-preferred resources for positioning reference signal, PRS, measurement at a terminal device in the communication network, determine updated PRS configuration for transmitting the PRSs at least based on the information of the one or more non-preferred resources, and transmit the PRSs based on the updated PRS configuration.

In a third aspect, an example embodiment of a location server in a communication network is provided. The location server may comprise at least one processor and at least one memory including computer program code. The at least one memory and the computer program code may be configured to, with the at least one processor, cause the location server at least to receive from a terminal device or a network device serving the terminal device, information of one or more non-preferred resources for positioning reference signal, PRS, measurement at the terminal device, and transmit a positioning configuration related indication to the terminal device and/or one or more network devices positioning the terminal device. The positioning configuration related indication is obtained in connection with the received information and it indicates the terminal device or the one or more network devices to update a positioning configuration to reduce PRS measurement of the terminal device on the one or more non-preferred resources.

Example embodiments of methods, apparatus and computer program products are also provided. Such example embodiments generally correspond to the example embodiments in the above aspects and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating a cellular communication network in which example embodiments of the present disclosure can be implemented.

FIG. 2 is a high-level message flow diagram illustrating a positioning configuration update process in accordance with some example embodiments.

FIG. 3 is a schematic message flow diagram illustrating a positioning reference signal (PRS) configuration update process in accordance with some example embodiments.

FIG. 4 is a schematic message flow diagram illustrating a PRS measurement related configuration update process in accordance with some example embodiments.

FIG. 5 is a schematic structure block diagram illustrating devices in a communication system in which example embodiments of the present disclosure can be implemented.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “terminal device” or “user equipment” (UE) refers to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “network function” (NF) refers to a processing function in a network, and defines a functional behavior and an interface. The network function may be implemented by using dedicated hardware, or may be implemented by running software on dedicated hardware, or may be implemented on a form of a virtual function on a common hardware platform. From a perspective of implementation, network functions may be classified into a physical network function and a virtual network function. From a perspective of use, network functions may be classified into a dedicated network function and a shared network function.

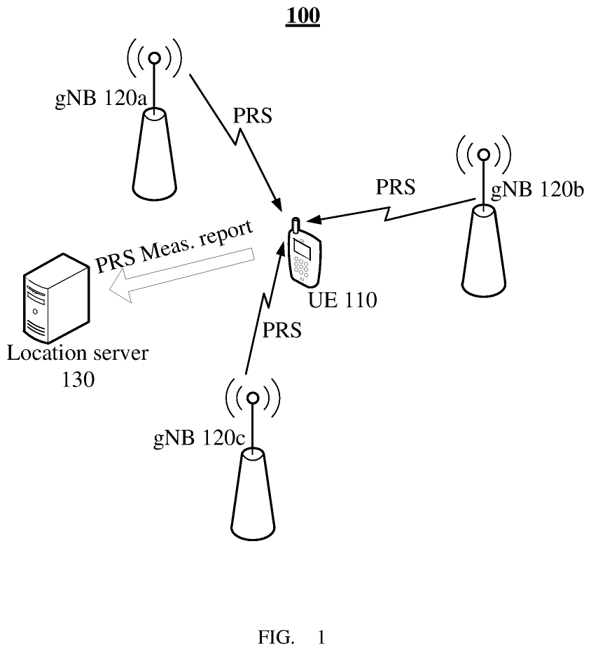

FIG. 1 illustrates a simplified schematic diagram of a cellular communication network 100 in which example embodiments of the present disclosure can be implemented. The cellular communication network 100 may be implemented as a multiple access system capable of supporting communication with multiple users sharing available system resources. The cellular communication network 100 may employ one or more channel access schemes such as Time Division Multiple Access (TDMA), Code Division Multiple Access (CDMA), Time Division Synchronous Code Division Multiple Access (TD-SCDMA), Frequency Division Multiple Access (FDMA), Orthogonal Frequency Division Multiple Access (OFDMA), Single Carrier Frequency Division Multiple Access (SC-FDMA) and the like. These multiple access schemes may be formulated in 4G Long Term Evolution (LTE), 5G New Radio (NR), or beyond 5G radio standards. For convenience of description, FIG. 1 shows the cellular communication network 100 as a 5G NR network including a plurality of 5G base stations “gNB”, but it would be appreciated that example embodiments disclosed herein can also be implemented in a 4G LTE network or a beyond 5G network.

Referring to FIG. 1, the communication network 100 may include a user equipment (UE) 110 and a plurality of base stations (shown as gNBs) 120a, 120b, 120c. The plurality of base stations 120a, 120b, 120c, collectively referred to as base stations 120, may form a so-called Radio access network (RAN) and provide network access to a plurality of UEs. For example, the UE 110 may camp in a cell supported by the base station 120a and establish a radio resource control (RRC) connection with the base station 120a. The UE 110 may communicate with the base station 120a on uplink and downlink channels. The base station 120a may be referred to as a serving base station for the UE 110, and the base stations 120b, 120c may be referred to as neighbor base stations.

In some example embodiments, the communication network 100 may employ a multiple transmission reception point (mTRP) architecture where the UE 110 can transmit data to and receive data from one or more transmission reception points (TRPs). The TRPs may be associated with one or more base stations 120 and/or one more cells. The term “cell” used herein may refer to a particular geographic coverage area served by a base station and/or a subsystem of the base station serving the coverage area, depending on the context in which the term is used. It would be appreciated that when the description herein indicates that a “cell” performs functions, a base station serving the cell would perform the functions. Example embodiments described herein are not limited to any particular deployment of the TRPs or a particular relationship between the TRPs and the base stations/cells. It would also be appreciated that throughout the present disclosure, the term “base station” may also comprise a TRP, and operations performed at a base station may be performed at least partially at a TRP.

With continuous reference to FIG. 1, the communication network 100 may further comprise a location server 130 to manage positioning of UEs in the communication network 100. The location server 130 may be a physical or logical entity which may be implemented as a local location management component (LMC) in a base station or as a location management function (LMF) within a core network. The base stations 120 may connect to the core network through so called backhaul connections.

In a positioning procedure, the UE 110 may receive downlink positioning reference signals (PRSs) from the serving base station 120a and one or more neighbor base stations such as the base stations 120b, 120c. Throughout the present disclosure, the term “positioning reference signal” may refer to any downlink reference signal which can be used to perform positioning measurements, of which examples may include for example the synchronization signal block (SSB), the cell-specific reference signal, and the positioning reference signal defined in 3GPP specifications. The UE 110 may measure arrival time of the PRSs from the base stations 120 and calculate Downlink Time Difference of Arrival (DL-TDOA) by for example subtracting the arrival time of the PRSs received from the neighbor base stations 120b, 120c from the arrival time of the PRS received from the serving base station 120a. Here the serving base station 120a is regarded as a reference base station in the positioning procedure. The DL-TDOA measurement, also known as Reference Signal Time Difference (RSTD) measurement, may be sent in a PRS measurement report to the location server 130 where the DL-TDOA is converted into a distance difference between a first distance from the UE 110 to the serving base station 120a and a second distance from the UE 110 to the respective neighbor base stations 120b, 120c. Since the location server 130 knows positions of the base stations 120 (or positions of physical antennas of the base stations), the location server 130 can calculate a hyperbola from a distance difference between the serving base station and a neighbor base station, and an intersecting point of two or more such hyperbolas can be determined as a position of the UE 110. Here the DL-TDOA method is described as an example, and it would be appreciated that example embodiments discussed herein are not limited to the DL-TDOA positioning method.

In a sidelink or V2X communication scenario, the UE 110 may receive the PRSs from for example a roadside unit (RSU) or another UE carried on another vehicle. The RSU or the another UE who transmit the PRSs may be regarded as a TRP, and operations discussed below relating to the base stations 120 may be performed at least partially at the TRP.

The UE 110 may be configured with a measurement gap (MG) for PRS measurement, and during the measurement gap the UE 110 does not receive or transmit other signals or channels than the positioning reference signals. However, MG request and configuration steps would cause additional latency in the positioning procedure. To reduce the positioning latency, it would be desirable that the UE 110 can also perform positioning measurement outside the measurement gap.

On the other hand, the location server 130 collects PRS transmission (Tx) configurations from multiple base stations and determines a PRS receiving (Rx) configuration for a UE based on the collected PRS Tx configurations. An issue with the PRS Rx configuration determination is that the location server 130 has no idea of scheduling related information of the UE when it determines the PRS Rx configuration for the UE. If the location server 130 configures the UE to receive PRSs outside a measurement gap, the PRSs may likely collide with other signals or channels. The PRS transmissions may be wasted because the UE may have to receive the other signals or channels which have a higher priority than the PRSs. The collision will also cause interference between the PRSs and the other signals or channels. If the UE cannot measure sufficient PRSs in a certain period, the positioning accuracy and latency will be impacted.

Hereinafter, example embodiments of methods and apparatuses supporting a new positioning configuration procedure would be described in detail with reference to the drawings. In the example embodiments, a UE or a base station serving the UE may indicate to a location server one or more non-preferred resources for PRS measurement at the UE. Upon receiving the non-preferred resource information, the location server may decide to update positioning configuration for the UE or the base stations providing the positioning service to the UE. The example embodiments can reduce or avoid collision of PRS resources with other signals or channels and improve PRS transmission and reception efficiency. It would be appreciated that the example embodiments are also applicable to sidelink positioning where the PRS could be transmitted from a roadside unit (RSU) or another UE.

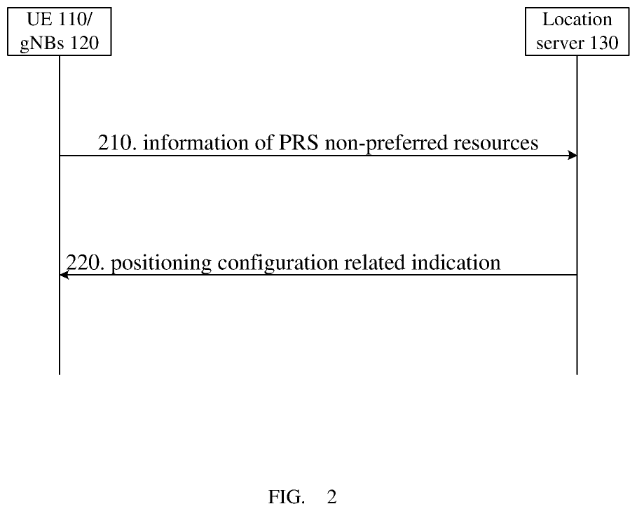

FIG. 2 is a high-level message flow diagram illustrating a positioning configuration update process in accordance with some example embodiments. It would be appreciated that the positioning configuration update process may comprise a process to determine an initial positioning configuration or a process to update the positioning configuration when the initial positioning configuration has been determined. The term “update” should be interpreted in a similar way throughout the present disclosure. The process shown in FIG. 2 may be performed by a location server and a user equipment, and in some example embodiments one or more base stations for positioning the UE may also be involved in the process. For example, the UE 110, the base stations 120 and the location server 130 in the communication network 100 described above with reference to FIG. 1 may be configured to perform the positioning configuration update process. The UE 110, the base stations 120 and the location server 130 each may include a plurality of components, modules, means or elements to perform operations discussed below, and the components, modules, means and elements may be implemented in various manners including but not limited to for example software, hardware, firmware or any combination thereof to perform the operations.

Referring to FIG. 2, at an operation 210, the location server 130 may receive from the UE 110 or from the serving base station 120a of the UE 110 information of one or more non-preferred resources for PRS measurement at the UE 110. For instance, if one or more resources have been allocated to other signals or channels such as persistent scheduling (PS) or semi-persistent scheduling (SPS) transmissions, high priority data or uplink transmissions, the UE 110 would prefer not to measure PRSs on the one or more resources because the UE 110 has to receive or transmit the other signals or channels using the one or more resources. Then the UE 110 or the serving base station 120a who knows uplink and downlink scheduling for the UE 110 may report the one or more non-preferred resources for PRS measurement at the UE 110 to the location server 130. Hereinafter, the resource non-preferred for PRS measurement may also be referred to as the PRS non-preferred resources.

When the location server 130 receives the information of the one or more PRS non-preferred resources, it knows that the UE does not prefer to measure PRSs on the non-preferred resources. The location server 130 may decide to update positioning configuration relating to the UE 110 and transmit a positioning configuration related indication to the UE 110 and/or the base stations 120 which are providing or will provide a positioning service to the UE 110, at an operation 220. The positioning configuration related indication may indicate the UE 110 and/or the base stations 120 to update the positioning configuration so as to reduce PRS measurement of the UE 110 on the one or more PRS non-preferred resources. The positioning configuration may include for example a PRS configuration for transmitting the PRSs at the base stations 120, a PRS configuration for receiving the PRSs at the UE 110, and a PRS measurement related configuration for measuring the PRSs at the UE 110. In some example embodiments, the positioning configuration related indication transmitted in the operation 220 may include at least one of the PRS configuration for receiving the PRSs at the UE 110, a request to change the PRS configuration for transmitting the PRSs at the base stations 120, and a request to change the PRS measurement related configuration for measuring the PRSs at the UE 110. Upon receiving the positioning configuration related indication, the UE 110 and/or the base stations 120 may update their positioning configuration accordingly, therefore the base stations may reduce or avoid PRS transmission for the UE 110 on the PRS non-preferred resources and the UE 110 may reduce or avoid PRS measurement on the PRS non-preferred resources. Here FIG. 2 shows only a high-level process for the positioning configuration update, and details of the operations in the process will be discussed below.

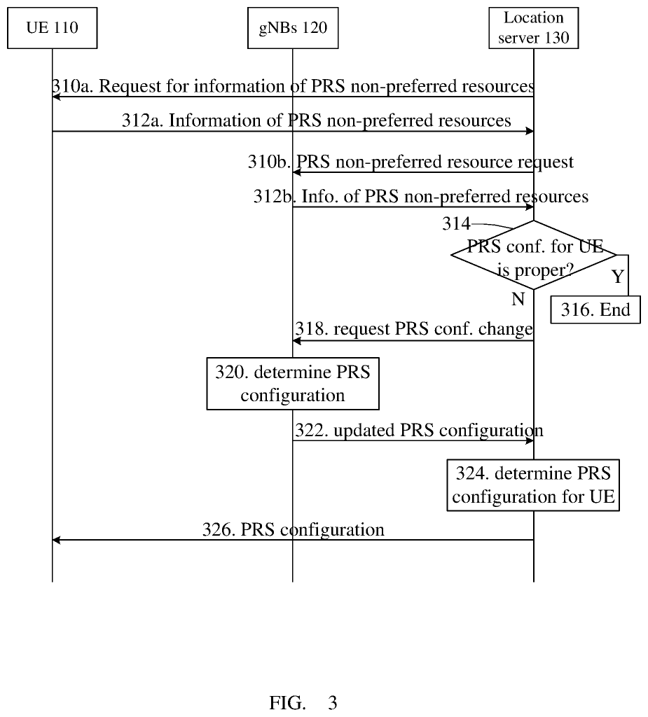

FIG. 3 is a schematic message flow diagram illustrating a positioning reference signal (PRS) configuration update process in accordance with some example embodiments. The process shown in FIG. 3 may be performed by for example the UE 110, one or more base stations 120 that are providing or will provide the positioning service to the UE 110, and the location server 130.

Referring to FIG. 3, at an operation 310a, the location server 130 may transmit to the UE 110 a request for information of one or more resources non-preferred for PRS measurement at the UE 110. For example, the request may be sent when the location server 130 determines an initial positioning service configuration for the UE 110. In some example embodiments, the location server 130 may re-use a UE capability transfer procedure to transmit the request for the PRS non-preferred resource information by adding a new information element (IE) in a RequestCapabilities message. Alternatively, the location server 130 may transmit the request for the PRS non-preferred resource information via a LTE Positioning Protocol (LPP) signaling, or a new signaling procedure may be defined to transmit the request.

In response to the request for the PRS non-preferred resource information, the UE 110 may transmit the PRS non-preferred resource information to the location server 130 at an operation 312a. The PRS non-preferred resource information may indicate one or more resources where the UE 110 does not prefer to receive or measure PRS transmissions. For example, if resources have been allocated to pre-configured uplink/downlink channels or signals with a higher priority, e.g., downlink persistent scheduling (PS) or semi-persistent scheduling (SPS) transmissions, periodic channel state information reference signal (CSI-RS), configured grant (CG) uplink transmissions, synchronization signal block (SSB) or periodic system information, the UE 110 cannot or does not prefer to receive or measure the PRSs on such resources and it may reports the resources to the location server 130 in the PRS non-preferred resource information.

In some example embodiments, the UE 110 may have been configured to receive PRSs outside a measurement gap (MG). For example, the serving base station 120a may configure a PRS processing window (PPW) and a PRS priority indication for the UE 110. When the configured PRS resources within the PPW overlap with other signals or channels, the UE 110 may receive the PRS resources if they have a higher priority than the other signals or channels or abandon the PRS resources if they have a lower priority than the other signals or channels. The UE 110 may determine the PRS non-preferred resources based on the PPW and PRS priority configuration received from the serving base station 120a. For example, the UE 110 may identify the low priority PRS resources within the PPW as the PRS non-preferred resources.

The PRS non-preferred resource information may indicate the PRS non-preferred resources in the frequency domain and/or in the time domain. For example, the frequency domain information may include e.g. Point A (a common reference point), a starting PRB offset from Point A, and a frequency bandwidth of the PRS non-preferred resources in a bandwidth part (BWP). The time domain information may include e.g. periodicity, slot offset, repetition factor or relevant parameters to identify time slots of the PRS non-preferred resources. The time domain information may further include an indication of whether the resources are always not preferred for PRS measurement at the UE 110 (e.g., resources where high priority periodic signal/channel is transmitted) or may become preferable or suitable for PRS measurement at the UE 110 in a dynamic fashion (e.g., resources where SPS is transmitted). If the resources may become preferable or suitable for PRS measurement, the time domain information may further indicate the timing when the UE 110 would prefer to measure the PRSs on the indicated resources. In some example embodiments, the time domain information may include a time divisional duplex (TDD) configuration applied to the UE 110 and the serving base station 120a, and the uplink symbols indicated by the TDD configuration may be regarded as the resources non-preferred for PRS measurement.

In some example embodiments where beamforming is supported, the PRS non-preferred resource information may further include spatial domain information indicative of a beam associated with the PRS non-preferred resources. For example, the spatial domain information may include a synchronization signal block (SSB) index associated with the beam or quasi-colocation (QCL) source information of the beam.

In some example embodiments, the PRS non-preferred resource information may also indicate the PRS non-preferred resources in a code domain. For example, in a code divisional multiple access (CDMA) system, a base station multiplies signals/channels by an orthogonal code sequence before transmitting the signals/channels to a UE, and the UE uses the orthogonal code sequence to extract the signals/channels. The PRS non-preferred resource information may include the orthogonal code sequence assigned to the UE 110 to identify the resources non-preferred for PRS measurement at the UE 110.

As discussed above, the UE 110 may re-use the UE capability transfer procedure to transmit the PRS non-preferred resource information to the location server 130. For example, the PRS non-preferred resource information may be carried in a ProvideCapabilities message. Alternatively, the UE 110 may transmit the PRS non-preferred resource information via the LTE Positioning Protocol (LPP) signaling e.g. ProvideLocationInformation, or a new signaling procedure may be defined to transmit the PRS non-preferred resource information.

In some example embodiments, the UE 110 may transmit the PRS non-preferred resource information to the location server 130 in the absence of the PRS non-preferred resource information request, and the operation 310a may be omitted. This example embodiment may be applicable for example when the positioning service already starts for the UE 110. The UE 110 may trigger reporting of the PRS non-preferred resource information when one or more predetermined conditions are satisfied. For instance, when a number of PRS resources available (or unavailable) in a certain period e.g. within the PPW is less (or higher) than or equal to a threshold, the UE 110 may trigger the reporting of the PRS non-preferred resource information. Unavailability of the PRS resources may result from collision with other signals or channels having a higher priority, unknown interference or other reasons. The number of available or unavailable PRS resources may be represented by an absolute value of the available or unavailable PRS resources or a relative value such as a percentage or rate of the available or unavailable PRS resources relative to the total PRS resources. If the UE 110 cannot receive sufficient PRSs in the certain period, positioning latency will be increased and positioning accuracy will be impacted. Hence the UE 110 may report the PRS non-preferred resource information to the location server 130 in order to improve the positioning configuration for the UE 110. For another instance, when PRS measurement quality at the UE 110 is lower than or equal to a threshold, the UE 110 may trigger the reporting of the PRS non-preferred resource information. The PRS measurement quality may be represented by for example reference signal received power (RSRP), reference signal received quality (RSRQ), or signal to interference and noise ratio (SINR) of the received PRSs, which may deteriorate when the PRS resources overlap with other signals or channels. For yet another instance, the UE 110 may also trigger the reporting of the PRS non-preferred resource information when positioning performance e.g. latency, accuracy becomes worse than or equal to a threshold.

In the above example embodiments, the PRS non-preferred resource information is provided from the UE 110 to the location server 130. In some other example embodiments, alternatively, the serving base station 120a of the UE 110 may provide the PRS non-preferred resource information of the UE 110 to the location server 130. For example, the location server 130 may send the request for the PRS non-preferred resource information to the serving base station 120a in an operation 310b, and the request may comprise an identity of the UE 110. As the serving base station 120a has knowledge of downlink and uplink resource scheduling for the UE 110, the serving base station 120a may generate the PRS non-preferred resource information for the UE 110 and send the generated information to the location server 130 in an operation 312b. As another option, the serving base station 120a may request the PRS non-preferred resource information from the UE 110 and then send the information received from the UE 110 to the location server 130. The request for the PRS non-preferred resource information and the report of the PRS non-preferred resource information may be conveyed via NR Positioning Protocol a (NRPPa) signaling. Other aspects of the operations 310b, 312b may be similar to the operations 310a, 312a, respectively, and a redundant description thereof is omitted here.

If the location server 130 has provided a PRS configuration to the UE 110, i.e., the positioning service for the UE 110 already starts, the location server 130 may determine based on the received PRS non-preferred resource information whether the current PRS configuration for the UE 110 is proper, at an operation 314. For example, if the PRS resources currently configured for the UE 110 do not overlap with the PRS non-preferred resources, or if the PRS resources currently configured for the UE 110 overlap with the PRS non-preferred resources within a threshold extent, the location server 130 may determine that the current PRS configuration for the UE 110 is proper, and the process may end at an operation 316. The location server 130 may continue to monitor the PRS non-preferred resource information report from the UE 110 or the base stations 120. On the other hand, if the PRS resources currently configured for the UE 110 overlap with the PRS non-preferred resources beyond the threshold extent, the location server 130 may determine that the current PRS configuration for the UE 110 is not proper, and the process may proceed to an operation 318.

At the operation 318, the location server 130 may transmit a request to change PRS configuration to one or more base stations 120. The request to change PRS configuration may include a simple indication to change the PRS configuration for transmitting the PRSs at the base station. In some example embodiments, the request to change PRS configuration may further include information of preferred and/or non-preferred PRS resources. For example, the request to change PRS configuration may include the PRS non-preferred resource information received from the UE 110. In some example embodiments, the location server 130 may receive the PRS non-preferred resource information from plural UEs which receive PRSs from a certain base station. The location server 130 may determine PRS preferred and/or non-preferred resources based on the PRS non-preferred resource information received from the plural UEs and send information of the determined PRS preferred and/or non-preferred resources to the base station at the operation 318.

Upon receiving the request to change PRS configuration from the location server 130, the base stations 120 may determine updated PRS configuration for transmitting the PRSs at an operation 320. For example, if the request to change PRS configuration includes a simple indication to change the PRS configuration, the base stations 120 may change their PRS transmission configuration randomly or to another pre-configured PRS transmission configuration. If the request to change PRS configuration further includes the preferred and/or non-preferred PRS resources, the base stations 120 may determine the updated PRS configuration at least based on the preferred and/or non-preferred PRS resources. For example, the base stations 120 may shift PRS transmissions by a certain number of subcarriers or physical resource blocks (PRBs) in the frequency domain or by a certain number of symbols, slots or subframes in the time domain to overlap with the preferred PRS resources or avoid the non-preferred PRS resources. The base stations 120 may report the updated PRS transmission configuration to the location server 130 at an operation 322 and transmit the PRSs according to the updated PRS transmission configuration.

It would be appreciated that if the positioning service for the UE 110 already starts, the location server 130 may send the request to change the PRS transmission configuration to one or more base stations which are providing the positioning service to the UE 110 and/or one or more new base stations which have not yet provided the positioning service to the UE 110. For example, the location server 130 may add one or more new base stations to provide the positioning service to the UE 110. In some example embodiments, the location server 130 does not need to change the PRS configuration at the base stations, and the operations 318, 320, 322 may be omitted.

With continuous reference to FIG. 3, the location server 130 may determine an updated PRS configuration for the UE 110 to receive the PRSs at an operation 324. As mentioned above, the updated PRS configuration here may comprise an initial PRS configuration for the UE 110 when the location server 130 initially configure a positioning service for the UE 110 or an updated/modified PRS configuration for the UE 110 when the location server 130 already configures the positioning service for the UE 110, i.e., the position service for the UE 110 already starts. The location server 130 may determine the PRS configuration for the UE 110 based on the PRS non-preferred resources received from the UE 110 and the PRS configurations at one or more base stations 120. For example, the location server 130 may configure PRS resources for the UE 110 to reduce or avoid overlap with the PRS non-preferred resources. Then, the location server 130 may transmit the updated PRS configuration to the UE 110 at an operation 326. The PRS configuration for the UE 110 may indicate frequency domain, time domain and spatial domain resources for the UE 110 to receive and measure PRSs. In some example embodiments, the PRS configuration may be transmitted via NRPPa signaling e.g. NR-DL-PRS-Info to the UE 110.

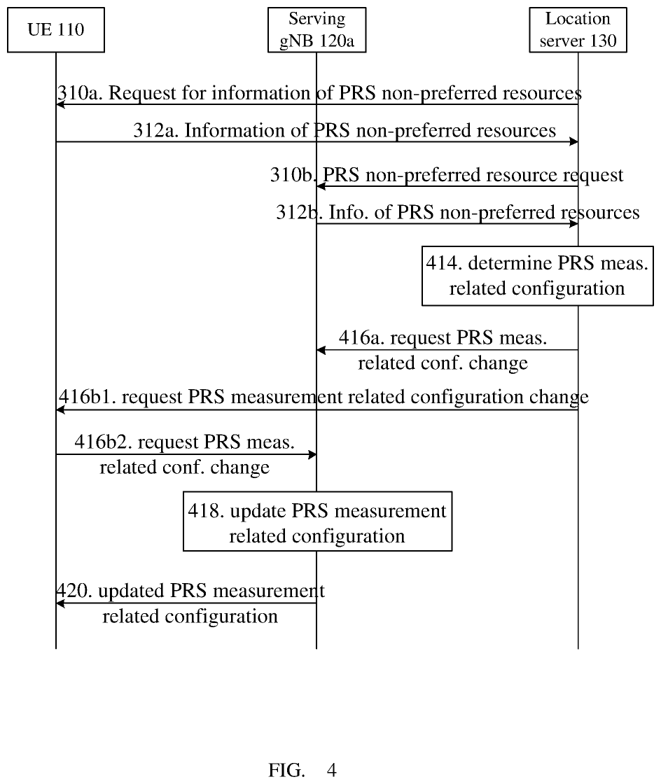

In the example embodiments discussed above with respect to FIG. 3, the location server 130 changes the PRS configuration at the UE 110 and optionally the PRS configuration at one or more base stations 120 in response to the PRS non-preferred resource information received from the UE 110 or the serving base station 120a. In some example embodiments, the location server 130 may also change the PRS measurement related configuration for the UE 110 when it receives the PRS non-preferred resource information from the UE 110. FIG. 4 is a schematic message flow diagram illustrating a PRS measurement related configuration update process in accordance with some example embodiments. The process shown in FIG. 4 may be performed by for example the UE 110, the serving base station 120a of the UE 110, and the location server 130.

Referring to FIG. 4, at the beginning of the process, the location server 130 may receive PRS non-preferred resource information from the UE 110 by the operations 310a, 312a or from the serving base station 120a by the operations 310b, 312b. The operations 310a, 312a, 310b, 312b have been described above with respect to FIG. 3 and a reductant description is omitted here.

At an operation 414, the location server 130 may determine PRS measurement related configuration for the UE 110 at least based on the received PRS non-preferred resource information. In some example embodiments, the location server 130 may determine a measurement gap configuration and/or a PRS processing window (PPW) configuration for the UE 110 to minimize the possibility of the measurement gap and/or PPW occasions overlapping with the PRS non-preferred resources. In some example embodiments, the location server 130 may determine PRS priority within the PPW according to the PRS non-preferred resource information. For example, the location server 130 may configure a higher priority for PRS resources within the PPW.

The location server 130 may send a request to change PRS measurement related configuration to the serving base station 120a of the UE 110 at an operation 416a or to the UE 110 at an operation 416b1. The request may include a simple indication to change the PRS measurement related configuration of the UE 110, or it may include suggested/recommended PRS measurement related configuration for the UE 110. For example, the request may include at least one of the measurement gap configuration, the PPW configuration and the PRS priority configuration determined at the location server 130 for the UE 110. The location server 130 may send the request to the UE 110 via LPP signaling or to the serving base station 120a via NRPPa signaling. If the request is sent to the UE 110 in the operation 416b1, the UE 110 may further transmit the request to the serving base station 120a at an operation 416b2. For example, the UE 110 may transmit the request via RRC signaling to the serving base station 120a.

Upon receiving the request to change the PRS measurement related configuration for the UE 110, the serving base station 120a may update the PRS measurement related configuration of the UE 110 at least based on the received request, at an operation 418. It would be noted that when the location server 130 determines the PRS measurement related configuration for the UE 110 at the operation 414, the location server 130 has no idea of scheduling information of the UE 110. Then at the operation 418, the serving base station 120a may take into consideration of uplink and downlink scheduling information of the UE 110 and determine appropriate PRS measurement related configuration for the UE 110 based on the PRS measurement related configuration determined for the UE 110 at the location server 130. It would be appreciated that, in some example embodiments, the PRS configuration for the base stations 120 and the PRS configuration for the UE 110 may not be changed, and PRS measurement of the UE 110 on the PRS non-preferred resources may be reduced or avoided by changing the PRS measurement related configuration for the UE 110. The PRS measurement related configuration determined at the serving base station 120a may include at least one of the measurement gap configuration, the PPW configuration and the PRS priority configuration for the UE 110. For example, the serving base station 120a may configure, shift or restrict the measurement gap and/or the PPW for the UE 110 to minimize the possibility of the PRS measurement occasions overlapping with the PRS non-preferred resources and possibly other scheduled data transmissions of the UE 110, or configure a high priority for PRS resources within the PPW to ensure that the PRS resources within the PPW would be measured.

Then at an operation 420, the serving base station 120a may transmit the updated PRS measurement related configuration to the UE 110. The UE 110 may apply the PRS measurement related configuration and then measure the PRS resources according to the configuration.

In the above example embodiments, the PRS configuration update process and the PRS measurement related configuration update process are described separately with respect to FIGS. 3-4. It would be appreciated that the location server 130 may, upon receiving the PRS non-preferred resource information from the UE 110 or the serving base station 120a of the UE 110, update or trigger update of both the PRS configurations and the PRS measurement related configuration relating to the UE 110 to minimize PRS measurement of the UE 110 on the PRS non-preferred resources. Again, throughout the present disclosure, the term “update” may refer to initial determination of an object or modification of a previously determined object, depending on the context in which the term is used.

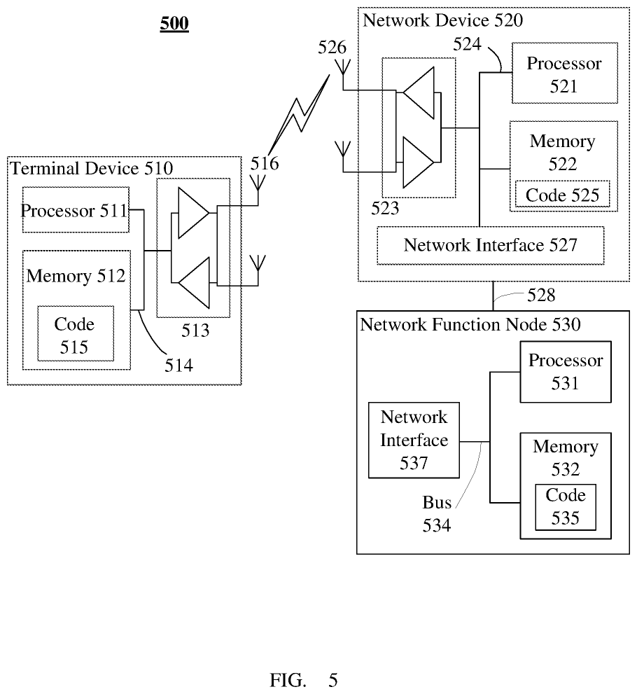

FIG. 5 illustrates a block diagram of an example communication system 500 in which embodiments of the present disclosure can be implemented. As shown in FIG. 5, the communication system 500 may comprise a terminal device 510 which may be implemented as the UE 110 discussed above, a network device 520 which may be implemented as any one of the base stations 120 discussed above, and a network function node 530 which may be implemented as the location server 130 discussed above. In some example embodiments, alternatively, the location server 130 may be implemented as a component or part in the network device 520. Although FIG. 5 shows one network device 520, it would be appreciated that the communication system 500 may comprise a plurality of network devices 520 to position or assist positioning of the terminal device 510.

Referring to FIG. 5, the terminal device 510 may comprise one or more processors 511, one or more memories 512 and one or more transceivers 513 interconnected through one or more buses 514. The one or more buses 514 may be address, data, or control buses, and may include any interconnection mechanism such as series of lines on a motherboard or integrated circuit, fiber, optics or other optical communication equipment, and the like. Each of the one or more transceivers 513 may comprise a receiver and a transmitter, which are connected to one or more antennas 516. The terminal device 510 may wirelessly communicate with the network device 520 through the one or more antennas 516. The one or more memories 512 may include computer program code 515. The one or more memories 512 and the computer program code 515 may be configured to, when executed by the one or more processors 511, cause the terminal device 510 to perform operations and procedures relating to the UE 110 as described above.

The network device 520 may comprise one or more processors 521, one or more memories 522, one or more transceivers 523 and one or more network interfaces 527 interconnected through one or more buses 524. The one or more buses 524 may be address, data, or control buses, and may include any interconnection mechanism such as a series of lines on a motherboard or integrated circuit, fiber, optics or other optical communication equipment, and the like. Each of the one or more transceivers 523 may comprise a receiver and a transmitter, which are connected to one or more antennas 526. The network device 520 may operate as a base station for the terminal device 510 and wirelessly communicate with terminal device 510 through the one or more antennas 526. The one or more network interfaces 527 may provide wired or wireless communication links through which the network device 520 may communicate with other network devices, entities, elements or functions. The one or more memories 522 may include computer program code 525. The network device 520 may communicate with the network function node 530 via backhaul connections 528. The one or more memories 522 and the computer program code 525 may be configured to, when executed by the one or more processors 521, cause the network device 520 to perform operations and procedures relating to any one of the base stations 120.

The network function node 530 may comprise one or more processors 531, one or more memories 532, and one or more network interfaces 537 interconnected through one or more buses 534. The one or more buses 534 may be address, data, or control buses, and may include any interconnection mechanism such as a series of lines on a motherboard or integrated circuit, fiber, optics or other optical communication equipment, and the like. The network function node 530 may operate as a core network function node and wired or wirelessly communicate with the network device 520 through one or more links. The one or more network interfaces 537 may provide wired or wireless communication links through which the network function node 530 may communicate with other network devices, entities, elements or functions. The one or more memories 532 may include computer program code 535. The one or more memories 532 and the computer program code 535 may be configured to, when executed by the one or more processors 531, cause the network function node 530 to perform operations and procedures relating to the location server 130 as described above.

The one or more processors 511, 521 and 531 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 1011, 1021 and 1031 may be configured to control other elements of the UE/network device/network element and operate in cooperation with them to implement the procedures discussed above.

The one or more memories 512, 522 and 532 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 512, 522 and 532 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide computer program code or instructions which, when executed by one or more processors, may cause a device or apparatus to perform the procedures described above. The computer program code for carrying out procedures of the exemplary embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some exemplary embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. An apparatus in a communication network comprising:
at least one processor; and
at least one memory including computer program code, the at least one memory and the computer program code being configured to, with the at least one processor, cause the apparatus at least to:
transmit to a location server in the communication network, information of one or more non-preferred resources for positioning reference signal, PRS, measurement at a terminal device in the communication network; and
receive a positioning configuration related indication from the location server, wherein the positioning configuration related indication is obtained in connection with the transmitted information and it indicates the apparatus to update a positioning configuration to reduce PRS measurement of the terminal device on the one or more non-preferred resources.

2. The apparatus of claim 1 wherein the information of the one or more non-preferred resources is transmitted when at least one of following conditions is satisfied:
a request for the information is received from the location server;
a number of available PRS resources is less than or equal to a first threshold;
PRS measurement quality is lower than or equal to a second threshold; and
positioning performance is worse than or equal to a third threshold.

3. The apparatus of claim 1 wherein the information of the one or more non-preferred resources is indicative of the one or more non-preferred resources in at least one of a frequency domain, a time domain, a spatial domain and a code domain.

4. The apparatus of claim 1 wherein the positioning configuration related indication comprises at least one of a PRS configuration for receiving PRSs at the terminal device, a request to change a PRS configuration for transmitting the PRSs at a network device in the communication network and a request to change PRS measurement related configuration for measuring the PRSs at the terminal device.

5. The apparatus of claim 4 wherein the request to change the PRS configuration for transmitting the PRSs comprises at least one of an indication to change the PRS configuration for transmitting the PRSs, information of preferred PRS resources, and information of non-preferred PRS resources.

6. The apparatus of claim 4 wherein the request to change the PRS measurement related configuration comprises an indication to change the PRS measurement related configuration and/or at least one of a measurement gap configuration, a PRS processing window configuration and a PRS priority configuration for the terminal device.

7. The apparatus of claim 4 wherein the apparatus comprises the terminal device when the positioning configuration related indication comprises the PRS configuration for receiving the PRSs or the request to change the PRS measurement related configuration.

8. The apparatus of claim 7 wherein the at least one memory and the computer program code are further configured to, with the at least one processor, cause the apparatus at least to:
transmit the request to change the PRS measurement related configuration to a network device in the communication network serving the terminal device, when the positioning configuration related indication comprises the request to change the PRS measurement related configuration.

9. The apparatus of claim 4 wherein the apparatus comprises the network device when the positioning configuration related indication comprises the request to change the PRS configuration for transmitting the PRSs or the request to change the PRS measurement related configuration.

10. The apparatus of claim 9 wherein the at least one memory and the computer program code are further configured to, with the at least one processor, cause the apparatus at least to:
when the positioning configuration related indication comprises the request to change the PRS configuration for transmitting the PRSs,
update the PRS configuration for transmitting the PRSs at least based on the request to change the PRS configuration for transmitting the PRSs; and
transmit, to the location server, the updated PRS configuration for transmitting the PRSs.

11. The apparatus of claim 9 wherein the at least one memory and the computer program code are further configured to, with the at least one processor, cause the apparatus at least to:
when the positioning configuration related indication comprises the request to change the PRS measurement related configuration,
update the PRS measurement related configuration for the terminal device at least based on the request to change the PRS measurement related configuration; and
transmit the updated PRS measurement related configuration to the terminal device.

12. An apparatus in a communication network comprising:
at least one processor; and
at least one memory including computer program code, the at least one memory and the computer program code being configured to, with the at least one processor, cause the apparatus at least to:
receive from a location server in the communication network, information of one or more non-preferred resources for positioning reference signal, PRS, measurement at a terminal device in the communication network;
determine updated PRS configuration for transmitting the PRSs at least based on the information of the one or more non-preferred resources; and
transmit the PRSs based on the updated PRS configuration.

13. A location server in a communication network comprising:
at least one processor; and
at least one memory including computer program code, the at least one memory and the computer program code being configured to, with the at least one processor, cause the location server at least to:
receive from a terminal device or a network device serving the terminal device in the communication network, information of one or more non-preferred resource for positioning reference signal, PRS, measurement at the terminal device; and
transmit a positioning configuration related indication to the terminal device and/or one or more network devices positioning the terminal device, wherein the positioning configuration related indication is obtained in connection with the received information and it indicates the terminal device or the one or more network devices to update a positioning configuration to reduce PRS measurement of the terminal device on the one or more non-preferred resources.

14. The location server of claim 13 wherein the at least one memory and the computer program code are further configured to, with the at least one processor, cause the location server at least to:
transmit a request for the information of the one or more non-preferred resources to the terminal device or the network device serving the terminal device before receiving the information of the one or more non-preferred resources.

15. The location server of claim 13 wherein the information of the one or more non-preferred resources is indicative of the one or more non-preferred resources in at least one of a frequency domain, a time domain, a spatial domain and a code domain.

16. The location server of claim 13 wherein the positioning configuration related indication comprises a PRS configuration for receiving PRSs at the terminal device, the PRS configuration for receiving the PRSs at the terminal device is determined at least partially based on the information of the one or more non-preferred resources and is transmitted to the terminal device.

17. The location server of claim 13 wherein the positioning configuration related indication comprises a request to change a PRS configuration for transmitting PRSs, the request to change the PRS configuration for transmitting PRSs being transmitted to the one or more network devices positioning the terminal device, and
wherein the at least one memory and the computer program code are further configured to, with the at least one processor, cause the location server at least to:
receive, from the one or more network devices positioning the terminal device, updated PRS configuration for transmitting the PRSs.

18. The location server of claim 17 wherein the request to change the PRS configuration for transmitting the PRSs comprises at least one of an indication to change the PRS configuration for transmitting the PRSs, information of preferred PRS resources, and information of non-preferred PRS resources.

19. The location server of claim 13 wherein the positioning configuration related indication includes a request to change PRS measurement related configuration for measuring PRSs at the terminal device, the request to change the PRS measurement related configuration being transmitted to the terminal device or to the network device serving the terminal device.

20. The location server of claim 19 wherein the request to change the PRS measurement related configuration comprises an indication to change the PRS measurement related configuration and/or at least one of a measurement gap configuration, a PRS processing window configuration and a PRS priority configuration, the request to change the PRS measurement related configuration being determined for the terminal device at least partially based on the information of the one or more non-preferred resources.

21-46. (canceled)
